(19) United States
(12) Patent Application Publication
(10) Pub. No.: US 2005/0284239 A1
(43) Pub. Date: Dec. 29, 2005

(54) Cell sampling device

(76) Inventor: Chi-Cheng Chuang, Chung-Li City (TW)

Correspondence Address: BANNER & WITCOFF, 1001 G STREET N W, SUITE 1100, WASHINGTON, DC, 20001, US

(21) Appl. No.: 10/994,387

(22) Filed: Nov. 23, 2004

(30) Foreign Application Priority Data
Jun. 29, 2004 (TW) 093210157

(51) Int. Cl. G01N 1/00

(52) U.S. Cl. 73/864

(57) ABSTRACT

A cell sampling device includes an outer tube unit having front and rear ends, a first tube inserted rotatably into the outer tube unit from the rear end, a second tube inserted slidably into the first tube and extendable forward or retractable into the first tube, a sample retriever connected to the second tube for simultaneous movement therewith, and a cam mechanism associated with the outer tube unit and the first and second tubes for rotating and moving forwardly the second tube and the sample retriever when the first tube is rotated relative to the outer tube unit. The sample retriever has a retrieving portion which is extendable outward from the front end of the outer tube unit to retrieve a sample.

### CROSS-REFERENCE TO RELATED APPLICATION

This application claims priority of Taiwanese Application No. 093210157, filed on Jun. 29, 2004.

### BACKGROUND OF THE INVENTION

1. Field of the Invention

The invention relates to a cell sampling device, more particularly to a cell sampling device that is easy to operate and that can prevent contamination of a cell sample.

2. Description of the Related Art

There are many different testing methods used to diagnose diseases in patients. Usually, the tools and the containers are sterilized first prior to the test. Citing a vaginal Pap test as an example, the main tool used is an Ayer's spatula or a cytobrush. Other tools, such as a cytopick, a cervix brush, etc., may also be used. Since a sampling tool needs to reach the Squamocolumnar junction (SCJ), it may be difficult to collect a cell sample from the correct area using the stick type of sampling tool. Furthermore, since the user cannot accurately locate the SCJ by herself, and attempts to do so may result in injury if the tool is inserted too deeply into the body cavity, she usually has to consult a professional, such as a doctor, for assistance. However, many users are disinclined to undergo such a test because they feel it is embarrassing, resulting in frequent delay of treatment.

When a sample is successfully collected, it is then placed into a container to prevent contamination of the sample during transport thereof to a laboratory. However, there exists the possibility of the doctor accidentally contacting the collected sample prior to placing the sample into the container. If the collected sample contains a virus, it will be transmitted to the doctor. Hence, the sampling device is not safe to use.

### SUMMARY OF THE INVENTION

Therefore, the object of the present invention is to provide a cell sampling device that is sufficiently easy to operate to enable a user to perform a self-test.

Another object of the present invention is to provide a cell sampling device that can prevent contamination of a cell sample while transporting the sample to a laboratory.

According to this invention, a cell sampling device comprises an outer tube unit having front and rear ends, a first tube inserted rotatably into the outer tube unit from the rear end, a second tube inserted slidably into the first tube and extendable forward or retractable into the first tube, a sample retriever connected to the second tube for simultaneous movement therewith, and a cam mechanism associated with the outer tube unit and the first and second tubes for rotating and moving forwardly the second tube and the sample retriever when the first tube is rotated relative to the outer tube unit. The sample retriever has a retrieving portion which is extendable outward from the front end of the outer tube unit to retrieve a sample.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of the preferred embodiment of a cell sampling device according to the present invention;

FIG. 2 illustrates a first tube of the preferred embodiment;

FIG. 3 illustrates a third tube of the preferred embodiment;

FIG. 4 illustrates a cross-sectional view of a sample retriever of the preferred embodiment having V-shaped channels;

FIG. 5 illustrates a cross-sectional view of a sample retriever of the preferred embodiment having U-shaped channels;

FIG. 6 illustrates a cross-sectional view of a sample retriever of the preferred embodiment having rounded surfaces;

FIG. 7 illustrates a schematic view of a sample retriever of the preferred embodiment having kernel-like bosses;

FIG. 8 is a schematic view, illustrating first to third tubes and a sample retriever of the preferred embodiment in an assembled state;

FIG. 9 is a sectional view, illustrating first to fourth tubes and the sample retriever of the preferred embodiment in an assembled state;

FIG. 10 is a view similar to FIG. 9, but with the sample retriever extending outwardly from the fourth tube and with a stop unit sleeved on the fourth tube;

FIG. 11 illustrates the cell sampling device of the present invention in a state of use; and

FIG. 12 is a view similar to FIG. 10, but with a cover, and the stop unit being removed.

### DETAILED DESCRIPTION OF THE PREFERRED EMBODIMENT

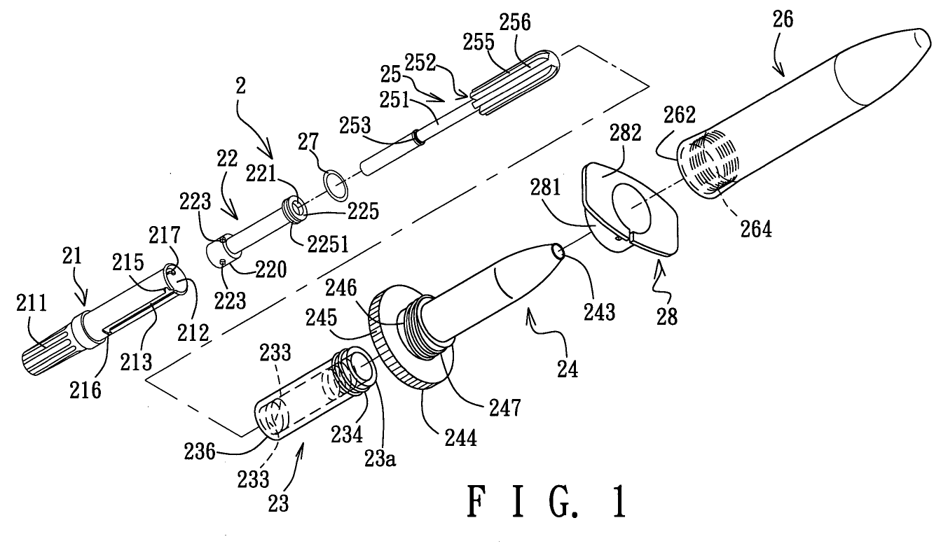

Referring to FIGS. 1 to 7, the preferred embodiment of a cell sampling device 2 according to the present invention is shown to comprise a first tube 21, a second tube 22, an outer tube unit, a sample retriever 25, and a cover 26.

The first tube 21 has a front open end 212, and a grip portion 211 for manual rotation of the first tube 21.

The second tube 22 is inserted slidably into the first tube 21 from the front open end 212, and is extendable forward or retractable into the first tube 21. The second tube 22 has enlarged front and rear ends 221, 220, an annular flange 225 projecting outwardly and integrally from the front end 221, an annular groove 2251 formed in the annular flange 225, and a seal ring 27 fitted in the annular groove 2251.

In this embodiment, the outer tube unit includes a third tube 23, and a fourth tube 24 connected to the third tube 24. The third tube 23 has a front end 23a provided with two annular protrusions 234 formed on an outer wall surface thereof to contact tightly an inner wall surface of the fourth tube 24. The first tube 21 is inserted rotatably into the third tube 23 from a rear end 23b thereof.

The fourth tube 24 has a tapered front open end 243, and includes an annular handle plate portion 244 which projects radially outward from a rear end of the fourth tube 24 and which has a knurled peripheral surface 245, and a raised surface portion 246 adjacent to the handle plate portion 244. The raised surface portion 246 includes an external first screw portion 247. The fourth tube 24 further includes a stop unit 28 sleeved removably on the fourth tube 24 forwardly of the handle plate portion 244. The stop unit 28 has a sleeve portion 281 sleeved on the fourth tube 24, and a wing portion 282 projecting outwardly from the sleeve portion 281. The length of the sleeve portion 281 maybe altered depending upon the depth of the Squamocolumnar junction (SCJ), which varies with age and race.

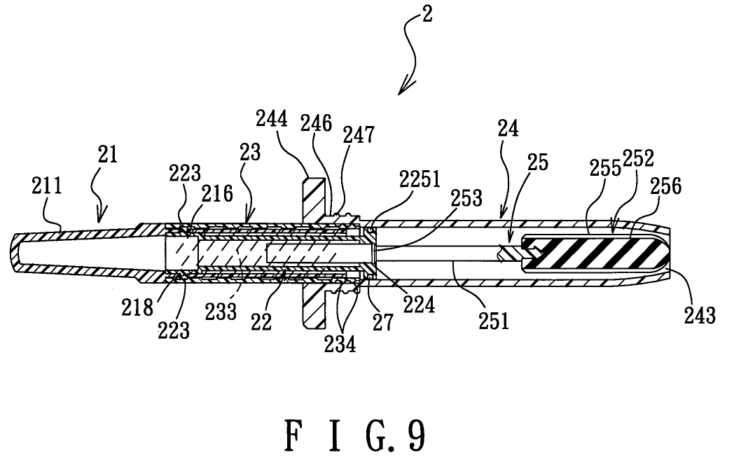

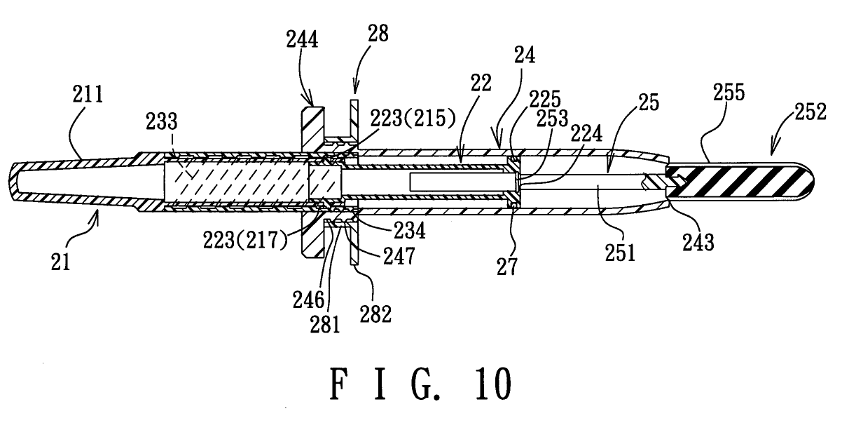

The sample retriever 25 is connected to the second tube 22 for simultaneous movement therewith, and has a connecting portion 251, and a retrieving portion 252 which is disposed on a distal end of the connecting portion 251 and which is extendable outward from the front open end 243 of the fourth tube 24 to retrieve a cell sample (not shown). The connecting portion 251 has a retainer 253 in tight fit with an inner wall surface 224 (see FIG. 9) of the second tube 22 at the front end 221 thereof.

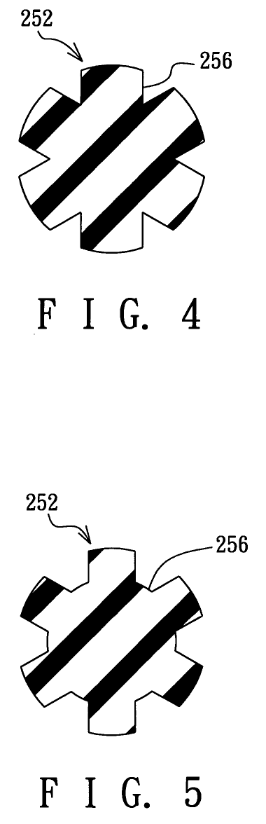

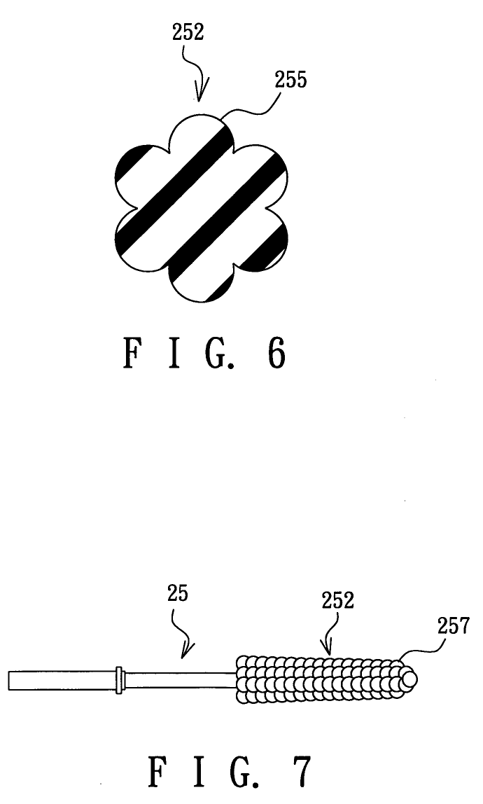

The construction of the retrieving portion 252 may be varied. In this embodiment, the retrieving portion 252 has a plurality of angularly arranged longitudinally extending projections 255 projecting from a peripheral surface of the retrieving portion 252, and a plurality of angularly spaced-apart longitudinally extending channels 256, each of which is defined by two adjacent ones of the projections 255. Each of the channels 256 may be substantially V-shaped, as shown in FIG. 4, or substantially U-shaped, as shown in FIG. 5. As another example, each of the projections 255 may have a rounded surface, as shown in FIG. 6.

With reference to FIG. 7, the retrieving portion 252 of the sample retriever 25, in an alternative embodiment, is provided with a plurality of kernel-like bosses 257 distributed on the peripheral surface of the retrieving portion 252.

A cam mechanism is associated with the outer tube unit and the first and second tubes 21, 22 for rotating and moving forwardly the second tube 22 and the sample retriever 25 when the first tube 21 is rotated relative to the outer tube unit. The cam mechanism may include at least one helical groove and a cam follower to slide along the helical groove. In this embodiment, the cam mechanism includes two helical grooves 233 formed in an inner surface of the third tube 23, two guide slots 213, 214 which are formed in the first tube 21 and which are opposed diametrically and extend axially, and two opposed protuberances 223 which are formed on the second tube 22 and which respectively extend through the guide slots 213, 214 and engage slidably the helical grooves 233. When the cam mechanism includes only one helical groove, the two protuberances 223 will engage the same helical groove at different heights thereof.

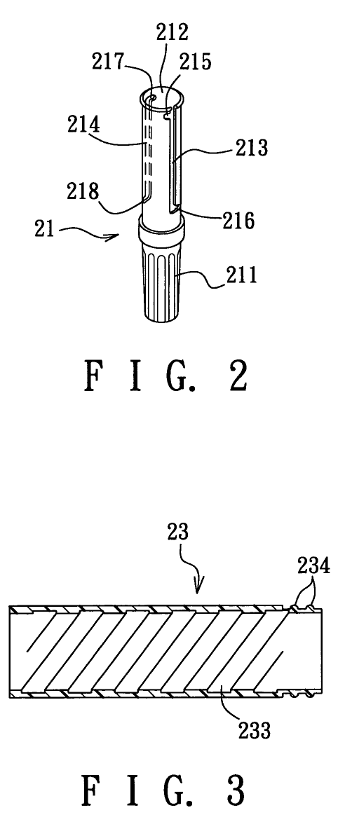

Each of the guide slots 213, 214 has two axially opposite angled ends 215, 216, 217, 218 (see FIG. 2) extending in opposite circumferential directions. In this embodiment, one of the guide slots 213, 214 extends through the front open end 212, the end result of which is that the first tube 21 comes to have some degree of flexibility.

The cover 26, as shown in FIG. 1, is detachably connected to the fourth tube 24, and is provided with a second screw portion 264 formed in an inner wall surface of the cover 26 adjacent to a rear open end 262 thereof to engage the first screw portion 247 when the cover 26 is positioned over the fourth tube 24.

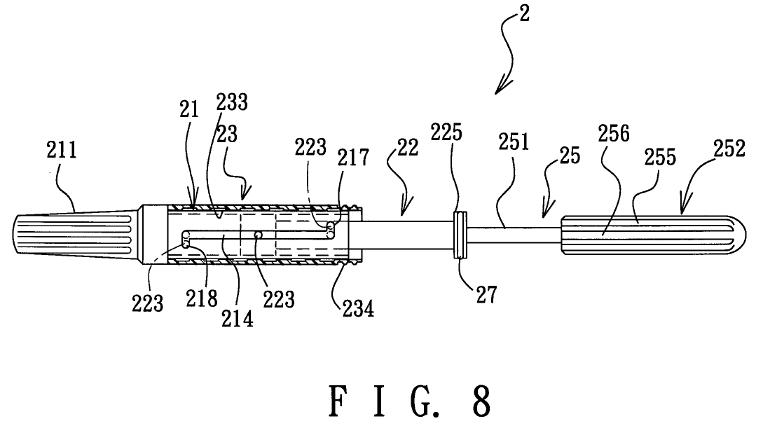

Referring to FIGS. 8 and 9, during assembly of the cell sampling device 2 of the present invention, the connecting portion 251 of the sample retriever 25 is inserted into the second tube 22 until the retainer 253 abuts tightly against the inner wall surface 224 of the second tube 22. Next, the second tube 22 is inserted into the first tube 21 with the protuberances 223 extending respectively through the guide slots 213, 214 (only the guide slot 214 is visible in FIG. 8) and positioned respectively at the angled ends 216, 218, and the seal ring 27 is disposed within the annular groove 2251. The third tube 23 is then sleeved on the first tube 21. The protuberances 223 engage respectively and slidably the helical grooves 233 in the third tube 23 at this time. Finally, the fourth tube 24 is sleeved on the third tube 23. At this time, the seal ring 27 and the annular protrusions 234 are in sliding contact with the inner wall surface of the fourth tube 24. The retainer 253 of the sample retriever 25 abuts tightly against the inner wall surface 224 of the second tube 22. Hence, the sample on the sample retriever 25 is prevented from entering the first to third tubes 21, 22, 23.

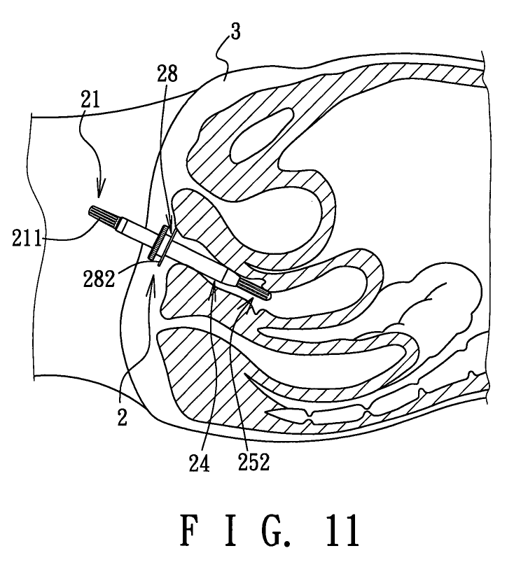

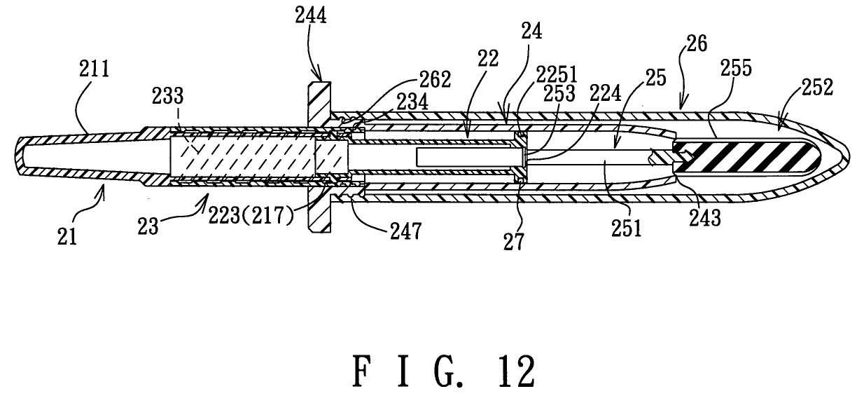

Referring to FIGS. 10 and 11, in combination with FIG. 9, during a sampling operation, the user grasps the handle plate portion 244 of the fourth tube 24, and sleeves threadedly the sleeve portion 281 of the stop unit 28 on the first screw portion 247 of the fourth tube 24. While one hand of the user holds the handle plate portion 244, the other hand of the user rotates the grip portion 211 of the first tube 21 in a first direction so as to move the protuberances 223 from the respective angled ends 216, 218 toward the angled ends 215, 217 along the helical grooves 233, thereby moving the retrieving portion 252 of the sample retriever 25 out of the front open end 243 of the fourth tube 24. The cell sampling device 2 is then inserted into a body cavity of the user.

After the cell sampling device 2 is inserted into the body cavity of the user, the grip portion 211 of the first tube 21 is rotated so that the projections 255 on the retrieving portion 252 of the sample retriever 25 scrape the cavity wall, and collect a sample therefrom. During insertion of the cell sampling device 2 into the body cavity, the wing portion 282 of the stop unit 28 abuts against an outer wall portion of the body cavity, thereby preventing the sample retriever 25 from moving too deeply into the body cavity. After the sample is collected, the cell sampling device 2 is withdrawn from the body cavity, and the stop unit 28 is removed from the fourth tube 24. Subsequently, the cover 26 is sleeved on the fourth tube 24 with the second screw portion 264 of the cover 26 engaging threadedly the first screw portion 247 of the fourth tube 24 so that the cover 26 is secured to the fourth tube 24, thereby providing quick and safe collection of the sample. Furthermore, since the user can operate the cell sampling device 2 by herself, embarrassing situations associated with receiving assistance from a professional health worker are avoided. Hence, the cell sampling device 2 of the present invention is safe and convenient to use, and allows for self-sampling to be performed.

It should be noted that the second tube 22 and the sample retriever 25 of the present invention may be formed integrally so that assembly of the components of the cell sampling device 2 can be simplified and quickly accomplished.

From the aforementioned description of the cell sampling device 2 of the present invention, it is apparent that by rotating the first tube 21, the protrusions 223 can move respectively along the helical grooves 233 so as to push the sample retriever 25 out of the front open end 243 of the fourth tube 24 to facilitate retrieval of a cell sample in a body cavity. After the sample is collected, the stop unit 28 is removed, and the cover 26 is covered on the fourth tube 24 so as to protect the sample from being contaminated during transport to a laboratory for examination. Therefore, the operation of the cell sampling device 2 of the present invention is simple enough to allow even an inexperienced user to accurately collect a sample by herself.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A cell sampling device comprising:
an outer tube unit having front and rear ends;
a first tube inserted rotatably into said outer tube unit from said rear end;
a second tube inserted slidably into said first tube and extendable forward or retractable into said first tube;
a sample retriever connected to said second tube for simultaneous movement therewith, and having a retrieving portion which is extendable outward from said front end of said outer tube unit to retrieve a sample; and
a cam mechanism associated with said outer tube unit and said first and second tubes for rotating and moving forwardly said second tube and said sample retriever when said first tube is rotated relative to said outer tube unit.

2. The cell sampling device as claimed in claim 1, wherein said cam mechanism includes a helical groove formed in an inner surface of said outer tube unit, and a cam follower formed on said second tube to slide along said helical groove.

3. The cell sampling device as claimed in claim 1, wherein said cam mechanism includes at least one helical groove formed in an inner surface of said outer tube unit, two guide slots which are formed in said first tube and which are opposed diametrically and extend axially, and two opposed protuberances which are formed on said second tube and which respectively extend through said guide slots to engage slidably said helical groove.

4. The cell sampling device as claimed in claim 3, wherein said outer tube unit includes a third tube and a fourth tube, said third tube having a front end connected to a rear end of said fourth tube, said helical groove being provided in said third tube.

5. The cell sampling device as claimed in claim 1, wherein said second tube further has a front end connected to said sample retriever, an annular flange projecting outwardly from said front end of said second tube to contact said inner surface of said outer tube unit, an annular groove formed in said annular flange, and a seal ring fitted in said annular groove.

6. The cell sampling device of claim 1, wherein said retrieving portion of said sample retriever has an elongated peripheral surface, and a plurality of angularly arranged longitudinally extending projections projecting from said peripheral surface.

7. The cell sampling device of claim 6, wherein said retrieving portion further has a plurality of angularly spaced-apart longitudinally extending channels, each of which is defined by two adjacent ones of said projections.

8. The cell sampling device of claim 8, wherein each of said channels is substantially V-shaped.

9. The cell sampling device of claim 8, wherein each of said channels is substantially U-shaped.

10. The cell sampling device of claim 8, wherein each of said projections has a rounded surface.

11. The cell sampling device of claim 1, wherein said retrieving portion of said sample retriever has an elongated peripheral surface, and a plurality of kernel-like bosses distributed on said peripheral surface.

12. The cell sampling device of claim 4, further comprising a cover detachably connected to said fourth tube, said fourth tube having a first screw portion, said cover being provided with a second screw portion for engaging said first screw portion when said cover envelops said fourth tube.

13. The cell sampling device of claim 12, wherein said fourth tube includes an annular handle plate portion which projects radially outward from said rear end of said fourth tube and which has a knurled peripheral surface.

14. The cell sampling device of claim 13, wherein said first screw portion is adjacent to said handle plate portion to engage threadedly said cover.

15. The cell sampling device of claim 13, wherein said fourth tube further includes a stop unit sleeved removably on said fourth tube forwardly of said handle plate portion, said stop unit having a sleeve portion sleeved on said fourth tube, and a wing portion projecting from said sleeve portion.
